(19) United States
(12) Patent Application Publication
(10) Pub. No.: US 2015/0129216 A1
(43) Pub. Date: May 14, 2015

(54) COMPOSITION AND METHOD FOR TREATING SUBTERRANEAN FORMATIONS USING INORGANIC FIBERS IN INJECTED FLUIDS

(71) Applicant: BAKER HUGHES INCORPORATED, Houston, TX (US)

(72) Inventors: SUMIT BHADURI, THE WOODLANDS, TX (US); TERRY MONROE, TOMBALL, TX (US); QI QU, SPRING, TX (US); FREEMAN HILL, SPRING, TX (US)

(73) Assignee: BAKER HUGHES INCORPORATED, Houston, TX (US)

(21) Appl. No.: 14/535,861

(22) Filed: Nov. 7, 2014

Related U.S. Application Data
(60) Provisional application No. 61/903,092, filed on Nov. 12, 2013.
(60) Provisional application No. 61/941,354, filed on Feb. 18, 2014.

(51) Int. Cl. C09K 8/508; C09K 8/514; E21B 43/16; E21B 33/12; E21B 43/24; E21B 33/13

(52) U.S. Cl. CPC C09K 8/5083; E21B 43/24; E21B 33/13; E21B 43/16; E21B 33/12; C09K 8/514
USPC 166/292; 166/305.1; 507/225; 507/209

(57) ABSTRACT

A method of plugging an opening in a subterranean formation such as a fracture system is provided. A gel composition can be provided which includes an aqueous fluid, a cross-linkable polymer soluble in the aqueous fluid and a cross-linking agent. Inorganic fibers can be added to the gel composition. The gel composition can be injected into the opening in the subterranean formation. The gel composition can be cross-linked, and the opening can be plugged with the gel composition. In certain illustrative embodiments, the inorganic fibers can be mineral wool fibers.

### RELATED APPLICATIONS

This application claims the benefit, and priority benefit, of U.S. Provisional Patent Application Ser. No. 61/903,092, filed Nov. 12, 2013, and U.S. Provisional Patent Application Ser. No. 61/941,354, filed Feb. 18, 2014, the contents of each of which are incorporated by reference herein in their entirety.

### BACKGROUND

1. Field of the Invention

The presently disclosed subject matter relates to a gel composition containing acid soluble inorganic fibers and use of the gel composition in oilfield applications.

2. Description of the Related Art

Oil and gas recovery from subterranean formations can be undesirably low for any number of reasons. For example, water from water-bearing regions within the formation can interfere with recovery operations. Also, cycling fluids from injection can bypass hydrocarbons in the formation, which can be an indication of poor sweep efficiency. The production of water from these water-bearing regions or poor sweep efficiencies can reduce the amount of oil or gas that can be recovered from the oil and gas producing regions in the formation. It is sometimes desirable to shut off, plug or block the water flow from these water-bearing regions or cycling, either completely or substantially, so that the oil or gas can be recovered more effectively.

There can also be problems when steam distribution is not as efficient as required from thermal treatment methods such as cyclic steam stimulation (“CSS”), “huff & puff” recovery, steam drive, steam flooding, steam assisted gravity drainage (“SAGD”), solvent aided distribution or other variations of steam/thermal applications. As with water or other solvents, the flow of steam and/or steam condensate will take the path of least resistance which can result in inefficient heating/melting of bitumen and hydrocarbons. This negative phenomenon can occur in vertical and horizontal wells. Improvements in conformance for steam/steam condensate and other solvent distribution means are desired.

### SUMMARY

According to certain illustrative embodiments disclosed herein, a gel composition for use in a subterranean formation is provided. The gel composition can include an aqueous fluid, a cross-linkable polymer soluble in the aqueous fluid, a cross-linking agent and inorganic fibers. In certain illustrative embodiments, the inorganic fibers can be mineral wool fibers.

In another aspect, a method of plugging an opening in a subterranean formation such as a fracture system is provided. A gel composition can be provided which includes an aqueous fluid, a cross-linkable polymer soluble in the aqueous fluid and a cross-linking agent. Inorganic fibers can be added to the gel composition. The gel composition can be injected into the opening in the subterranean formation. The gel composition can be cross-linked, and the opening can be plugged with the gel composition. In certain illustrative embodiments, the inorganic fibers can be mineral wool fibers.

In another aspect, a method of treating a gel composition disposed in a subterranean formation is provided. The gel composition can include an aqueous fluid, a cross-linkable polymer soluble in the aqueous fluid, a cross-linking agent and mineral wool fibers. An acid can be applied to the subterranean formation. The mineral wool fibers can be dissolved in the acid. The acid can include one or more from the group consisting of mineral acid and organic acid.

In another aspect, a method of unplugging an opening in a subterranean formation wherein the opening is at least partially filled with a cured gel composition is provided. The cured gel composition can include an aqueous fluid, a cross-linkable polymer soluble in the aqueous fluid, a cross-linking agent and mineral wool fibers. An acid can be supplied to the subterranean formation. The mineral wool fibers from the cured gel composition can be dissolved in the acid, and the cured gel composition can be softened. In certain illustrative embodiments, the acid can be one or more from the group consisting of mineral acid and organic acid.

In another aspect, a composition for use in a subterranean formation is provided. The composition can include an aqueous fluid, a polymer or viscous fluid soluble in the aqueous fluid, and inorganic fibers. In certain illustrative embodiments, the inorganic fibers can be mineral wool fibers. In certain illustrative embodiments, the composition can be an uncrosslinked gel system or polymer or viscous fluid composition.

In another aspect, a method of plugging an opening in a subterranean formation is provided. An uncrosslinked gel system or polymer or viscous fluid composition comprising an aqueous fluid and a polymer or viscous fluid soluble in the aqueous fluid can be provided. Inorganic fibers can be added to the uncrosslinked gel system or polymer or viscous fluid composition. The uncrosslinked gel system or polymer or viscous fluid composition can be injected into the opening in the subterranean formation. The opening can be plugged with the uncrosslinked gel system or polymer or viscous fluid composition. In certain illustrative embodiments, the inorganic fibers can be mineral wool fibers.

In another aspect, a method of treating a composition disposed in a subterranean formation is provided. The composition can include an aqueous fluid, a polymer or viscous fluid soluble in the aqueous fluid, and mineral wool fibers. An acid can be supplied to the subterranean formation. The mineral wool fibers can be dissolved in the acid. In certain illustrative embodiments, the acid can be one or more from the group consisting of mineral acid and organic acid. In certain illustrative embodiments, the composition can be an uncrosslinked gel system or polymer or viscous fluid composition.

In another aspect, a method of unplugging an opening in a subterranean formation, wherein the opening is at least partially filled with a cured uncrosslinked gel system or polymer or viscous fluid composition, is provided. The uncrosslinked gel system or polymer or viscous fluid composition can include an aqueous fluid, a polymer or viscous fluid soluble in the aqueous fluid, and mineral wool fibers. An acid can be supplied to the subterranean formation. The mineral wool fibers from the cured uncrosslinked gel system or polymer or viscous fluid composition can be dissolved in the acid. The uncrosslinked gel system or polymer or viscous fluid composition can be softened. In certain illustrative embodiments, the acid can include one or more from the group consisting of mineral acid and organic acid

In another aspect, a method of treating a subterranean formation is provided. The subterranean formation can be treated with a steam injection fluid. The steam injection fluid can include inorganic fibers. The steam injection fluid can be injected into the subterranean formation and distributed within the subterranean formation. The inorganic fibers can be mineral wool fibers. The steam injection fluid can be introduced to the subterranean formation by one or more of steam flooding, steam drive, cyclic steam stimulation, steam assisted gravity drainage, or huff & puff injection. The steam injection fluid can further include one or more of calcium carbonate, silicon oxide, acid soluble materials and non-acid soluble materials. The steam and inorganic fibers can be directly injected, provided in a carrier fluid, and/or staged in with a carrier fluid. The injection fluid can be introduced to the subterranean formation by one or more of steam flooding, steam drive, cyclic steam stimulation, steam assisted gravity drainage, or huff & puff injection. The injection fluid can include one or more of calcium carbonate, silicon oxide, acid soluble materials and non-acid soluble materials. The inorganic fibers can include mineral wool fibers that are provided in a mixture of fiber sizes. The inorganic fibers can include mineral wool fibers that have been reduced from their commercially available size

In another aspect, a method of enhancing the distribution of a fluid introduced into a subterranean formation is provided. Inorganic fibers can be added to the fluid, and the fluid can be introduced into the subterranean formation. The inorganic fibers can be mineral wool fibers. The fluid can be suspended in steam, cement or a solvent material (aqueous or hydrocarbon based), in various illustrative embodiments. The fluid can further include one or more of calcium carbonate, silicon oxide, acid soluble materials and non-acid soluble materials like fly ash and other pozzolanic materials, silica flour etc. The fluid can be introduced, bullheaded, staged in, or zone isolated and pumped into the subterranean formation or onto wellbore interface with the formation by one or more of steam injection, steam flooding, water flooding, steam drive, cyclic steam stimulation, steam assisted gravity drainage, no-condensate gas injection, huff & puff injection, cementing, enhanced solvent extraction incorporating electromagnetic heating or a cyclic solvent process, in various illustrative embodiments. By including the inorganic fibers in the fluid, distribution within the subterranean formation is enhanced.

In another aspect, a method of modifying the injection profile of a steam injection or other injection process for a subterranean formation is provided. Inorganic fibers can be introduced into the steam via direct injection or by carrier fluid. The steam containing the inorganic fibers can be injected into the subterranean formation. The inorganic fibers can be injected into the subterranean formation in stages. The inorganic fibers can be mineral wool fibers, in certain illustrative embodiments. The inorganic fibers can include mineral wool fibers that are provided in a mixture of fiber sizes. The inorganic fibers can include mineral wool fibers that have been reduced from their commercially available size.

In another aspect, a method of treating mineral wool fibers that have been introduced into a subterranean formation during a steam injection process is provided. An acid can be introduced into the subterranean formation. The acid can dissolve the mineral wool fibers in the formation. The acid can be one or more from the group consisting of mineral acid and organic acid, in certain illustrative embodiments.

In certain illustrative embodiments, the inorganic fibers described herein can be provided in a mixture of fiber sizes (for example, sizes ranging from 1 mesh to >600 mesh) and/or can be reduced from their commercially available sizes.

In another aspect, a gel composition for use in a subterranean formation is provided. The gel composition can include an aqueous fluid, a cross-linkable polymer soluble in the aqueous fluid, a cross-linking agent and inorganic fibers. The inorganic fibers can include mineral wool fibers provided in a mixture of fiber sizes.

In another aspect, a gel composition for use in a subterranean formation is provided. The gel composition can include an aqueous fluid, a cross-linkable polymer soluble in the aqueous fluid, a cross-linking agent, and inorganic fibers. The inorganic fibers can include mineral wool fibers that have been reduced from their commercially available size.

In another aspect, a method of enhancing the distribution of a fluid introduced into a subterranean formation is provided. Inorganic fibers can be added to the fluid. The fluid can be introduced onto a wellbore interface of the subterranean formation.

In another aspect, a method of modifying the injection profile of a steam or other injection process for a subterranean formation is provided. Inorganic fibers can be introduced into the injection stream. The injection stream can be injected onto a wellbore interface of the subterranean formation.

### BRIEF DESCRIPTION OF THE DRAWINGS

FIG. 1 is a graph showing Chandler 5550 viscosity comparisons for regular gels and fiber-laden gels over time in an illustrative embodiment.

FIGS. 2A-2C are photographs of filter cakes for various fluids after fluid loss testing in an illustrative embodiment.

While certain preferred illustrative embodiments will be described herein, it will be understood that this description is not intended to limit the subject matter to those embodiments. On the contrary, it is intended to cover all alternatives, modifications, and equivalents, as may be included within the spirit and scope of the subject matter as defined by the appended claims.

### DETAILED DESCRIPTION

Disclosed herein is a gel composition for improving water shut-off capability in subterranean formations. In certain illustrative embodiments, the gel composition can comprise an aqueous fluid, a cross-linkable polymer that is soluble in the aqueous fluid, and a cross-linking agent. The gel composition can be injected into the subterranean formation and allowed to penetrate the formation. Preferably, the gel composition effectively blocks the water-bearing regions while the oil or gas producing regions are left unblocked so that the oil or gas can be recovered.

In certain illustrative embodiments, the aqueous fluid can be water or a mixture of water and one or more organic solvents such as alcohols, glycols, and/or hydrocarbons.

In certain illustrative embodiments, the cross-linkable polymer can be a hydrophilic polymer that is generally soluble in the aqueous fluid and is capable of being cross-linked in solution so that the polymer interconnects to form a semi-solid gel. Examples of these polymers are well known to those skilled in the art. Those that can be utilized according to the presently disclosed subject matter can include polyacrylamide and partially hydrolyzed polyacrylamide polymers, polymers and copolymers of acrylic acid and acrylamide, cellulose ethers such as ethyl cellulose, methyl cellulose and cellulose derivatives, diutan, xanthan and xanthan derivatives, and substituted and unsubstituted galactomannans including guar gum and guar derivatives. Other suitable cross-linkable polymers may also be used in forming the gel composition of the presently disclosed subject matter, and are well known and will be readily apparent to those skilled in the art.

Various cross-linking agents are also well known to those skilled in the art. Examples of suitable cross-linking agents according to the presently disclosed subject matter can include the salts or complexes of the multivalent metals such as chromium, zirconium, titanium and aluminum. These cross-linking agents bond ionically with the polymers to form the cross-linked molecule. Other suitable cross-linking agents may be used in forming the gel composition of the presently disclosed subject matter, and are well known and will be readily apparent to those skilled in the art. Some of these include formaldehyde releasers such as hexamethylene tetramine or trioxane combined with phenol-based derivatives such as catechol, hydroquinone, or pyrogallol. The amount of cross-linking agent used will typically vary depending upon the type of polymer and the degree of cross-linking desired. Alternatively, in certain illustrative embodiments, the gel composition will not contain any cross-linking agents. Delaying agents and other additives may also be used with the gel composition like lactate.

The gel composition of the presently disclosed subject matter can further comprise inorganic fibers. In an illustrative embodiment, the inorganic fibers can comprise mineral wool fibers. Mineral wool fibers typically are produced from inorganic materials such as igneous rock (diabase, basalt or olivine) and blast furnace slag from the steel industry. Mineral wool fibers are an inert, non-damaging material towards the environment with an LC-50 of one million. In certain illustrative embodiments, the mineral wool fibers are acid-soluble and thermally stable in both aqueous and hydrocarbon media at temperatures up to 1,800 degrees F. Due to their unique mineralogy, the mineral wool fibers can be used in high temperature applications such as thermal insulation or sound dampening, and are more thermally resistant than glass wool fibers.

In an illustrative embodiment, the mineral wool fibers can be largely composed of Al₂O₃ and SiO₂, and possess higher alkaline earth oxide content (Al₂O₃, MgO, and CaO) and lower alkali metal oxide content (Na₂O and K₂O) than glass wool fibers. In another illustrative embodiment, the mineral wool fibers can be largely composed of CaO and SiO₂, and can also contain significant amounts of Al₂O₃, MgO, and Fe₂O₃. Examples of mineral wool fibers that are useful in the presently disclosed subject matter are MAGMA FIBER® which is commercially available from Lost Circulation Specialists, Inc., of Tomball, Tex., and THERMAFIBER® which is commercially available from Owens Corning (formerly Thermafiber, Inc. of Wabash, Ind.).

MAGMA FIBER® is available in a wide range of particle sizes. For example, it is commercially available in a “fine” form having a length of from about 0.1 to about 4 mm and a “regular” form having a length of from about 4 to about 20 mm with an average length of about 10 to about 16 mm. The fiber diameters of both grades of MAGMA FIBER® can range from about 5 to about 15 microns with an average diameter of about 7 to about 10 microns. THERMAFIBER® is also available in a wide range of sizes, with diameters ranging from 1.75 microns to 8.65 microns, with an average diameter of 5 microns, and lengths from 0.1 mm to 4.0 mm average.

Mineral wool fibers for use according to the presently disclosed subject matter may optionally be from either “fine” or “regular” form, or from a mixture of these forms as appropriate. In general, mineral wool fibers having a variety of lengths and diameters may be suitable for use with the presently disclosed subject matter. The diameter and length of the mineral wool fibers (and the corresponding aspect ratio) may be controlled during preparation thereof. In various illustrative embodiments, the appropriate length and diameter of the mineral wool fibers or mix of lengths and diameters or designated particle sizes made from material may be selected based on a particular application. In addition, other materials can be added, such as calcium carbonate or other acid soluble or non-soluble materials, to make treatment more efficient in modifying permeability or flow paths. For example, suitably sized mineral wool fibers can be added to the gel composition to bridge specific void spaces that are being targeted within the subterranean formation. The particle sizes and amount of the mineral wool fibers treatment will determine the open pore throat sizes or permeability within the formation that can be invaded and filled. Alternatively, the size of the pore throats within the formation that can be invaded and filled can determine the particle sizes of the mineral wool fibers or mix of sizes to be used, or whether the mineral wool fibers should be reduced even further from their commercial available sizes. In certain illustrative embodiments, the mineral wool fibers can be used, either alone or in the gel composition, to plug or partially reduce flow in fractures, pore throats, high permeability streaks and/or void spaces that require high thermal stability (steam flooding and such), thus resulting in a more efficient recovery sweep. The system could be used to modify injectivity profiles of water injectors, steam injectors or other types of injectors in secondary and enhanced oil recovery projects.

Table 1 below sets forth the chemical identity of various types of synthetic vitreous fibers. Table 1 includes values for mineral wool fibers in the acceptable range and the preferred range for use according to the presently disclosed subject matter. Certain of the values in Table 1 were obtained from “Chemical Identity of Some Types of Synthetic Vitreous Fibers,” at the website http://www.atsdr.cdc.gov/toxprofiles/tp161-c4.pdf, page 164.

TABLE 1
Chemical Identity of Some Types of Synthetic Vitreous Fibers

| | | | | | | | Rock Wool | Rock Wool |
|---|---|---|---|---|---|---|---|---|
| | | | | | | | (from | (from |
| | Mineral Wool | Mineral Wool | | | High | Alkali | Basalt) | Basalt) |
| % | (acceptable | (preferred | Glass | Electrical | Strength | Resistant | Furnace | Cupola |
| Composition | range) | range) | Wool | Glass | Glass | Glass | Melted | Melted |
| SiO₂ | 38-52 | 38-46 | 55-70 | 52-56 | 65 | 60.7 | 45-48 | 41-53 |
| Al₂O₃ | 5-15 | 9-12 | 0-7 | 12-16 | 25 | — | 12-13.5 | 6-14 |
| B₂O₃ | — | — | 3-12 | 5-10 | — | — | — | — |
| K₂O | 0-2 | — | 0-2.5 | 0-2 | — | 2 | 0.8-2 | 0.5-2 |
| Na₂O | 0-1 | — | 13-18 | 0-2 | — | — | 2.5-3.3 | 1.1-3.5 |
| MgO | 4-15 | 8-15 | 0-5 | 0-5 | 10 | — | 8-10 | 6-16 |
| CaO | 20-43 | 31-40 | 5-13 | 16-25 | — | — | 10-12 | 10-25 |
| TiO₂ | 0.3-1 | — | 0-0.5 | 0-1.5 | — | — | 2.5-3 | 0.9-3.5 |
| Fe₂O₃ | 0-2 | 0-2 | 0-0.5 | 0-0.8 | — | — | — | — |
| FeO | 0-2 | — | 0.1-0.5 | — | — | — | 11-12 | 3-8 |
| Li₂O | — | — | 0-0.5 | — | — | 1.3 | — | — |
| SO₃ | — | — | 0-0.5 | — | — | — | — | — |
| S | 0-2 | — | — | — | — | — | 0-0.2 | 0-0.2 |
| F₂ | — | — | 0-1 | 0-1 | — | — | — | — |
| BaO | — | — | — | — | — | — | — | — |
| ZrO₂ | — | — | — | — | — | 21.5 | — | — |
| P₂O₅ | 0-0.5 | — | — | — | — | — | — | — |
| Cr₂O₃ | — | — | — | — | — | — | — | — |
| ZnO | — | — | — | — | — | — | — | — |

The mineral wool fibers should be present in the gel composition of the presently disclosed subject matter in an amount sufficient to provide the desired properties. For example, mineral wool fibers have been tested and determined to be compatible with cross-linked polyacrylamide gel systems, thus making the mineral wool fibers an easy filler material that can be added in the field to provide improved gel strength when the gel composition cures within the formation.

In certain illustrative embodiments, the mineral wool fibers are present in the gel composition of the presently disclosed subject matter in an amount in the range of from about 0.1% to about 50% by weight. In certain illustrative embodiments, the mineral wool fibers are present in an amount in the range of from about 0.5% to about 25% by weight. In certain illustrative embodiments, the mineral wool fibers are present in an amount of 2.5% by weight.

Other additives suitable for use in operations in subterranean formations also may be added to the gel composition. These other additives can include, but are not limited to, biocide, scale inhibitor, corrosion inhibitor, paraffin inhibitor, asphaletene inhibitor, iron control, steam/production enhancement additives, and other commonly used oilfield chemicals and combinations thereof. Other materials can be added to the fibers to make the system more efficient in reducing and controlling permeability or flow in some areas. A person having ordinary skill in the art, with the benefit of this disclosure, will know the type and amount of additive useful for a particular application and desired result.

Various methods of treating subterranean formations using inorganic fibers are also disclosed herein. For example, disclosed herein is a method of plugging an opening in a subterranean formation. A gel composition is provided comprising an aqueous fluid, a cross-linkable polymer that is soluble in the aqueous fluid, and a cross-linking agent. Inorganic fibers can be added to the gel composition. In certain illustrative embodiments, the inorganic fibers comprise mineral wool fibers. The gel composition can be injected into the opening in the subterranean formation and cross-linked to plug the opening. The mineral wool fibers do not interfere with the cross-linking process and provide adequate plugging properties without adversely affecting the ability of the gel composition to be injected into the opening.

Also disclosed herein is a method of treating a gel composition that is disposed in a subterranean formation. One can be using a gel composition comprising an aqueous fluid, a cross-linkable polymer soluble in the aqueous fluid, a cross-linking agent and inorganic fibers. In certain illustrative embodiments, the inorganic fibers comprise mineral wool fibers. The mineral wool fibers in the gel composition are soluble in a mineral acid or an organic acid. To treat the gel composition, the mineral acid or organic acid can be supplied to the subterranean formation, and the mineral wool fibers can be dissolved in the mineral acid or organic acid. Other carriers or treatments that the inorganic fibers may be embodied in or added to would be uncrosslinked/linear gel systems or polymer systems or viscous crosslinked and linear viscous fluid systems.

Generally, mineral wool fibers can undergo dissolution in mineral acid or organic acid due to their amorphous nature. As used herein, the term “amorphous” to describe mineral wool fibers means not possessing a well-defined crystalline structure. In certain illustrative embodiments, the mineral acids or organic acids can function as an “acid flush” for the cured gel composition disposed within the subterranean formation. The mineral acids or organic acids can soften the gel composition as the mineral wool fibers dissolve in the acid. As used herein, the term “soften” means the gel composition loses its native gel strength and begins to flow in the direction of formation fluid flow. This provides a distinct advantage over the use of glass wool fibers or cellulosic fibers, which do not dissolve in the mineral acid or organic acid. The presently disclosed method is particularly useful when the cured gel composition has entered into a hydrocarbon-containing zone and permeability must be selectively restored to the zone in order to recover oil or gas deposits. The mineral acids or organic acids can be used to soften the cured gel composition, and the softened gel composition can be removed from the formation along with the oil or gas that is recovered.

Also disclosed herein is a method of unplugging an opening in a subterranean formation, wherein the opening is at least partially filled with a cured gel composition in accordance with the presently disclosed subject matter. A mineral acid can be supplied to the subterranean formation. The mineral wool fibers from the cured gel composition can be dissolved in the mineral acid to soften the cured gel composition, thus allowing the opening to become unplugged as the softened gel composition exits the opening.

Typically, glass wool fibers have a silica content of greater than 60% while mineral wool fibers have a silica content of less than 50%. Thus, the mineral wool fibers (e.g., THERMAFIBER®—CAS #65997-17-3) have lower silica content than glass wool (CAS #7631-86-9). Also, the presence of basic components (˜55%), increased CaO (˜40%) and MgO (˜15%) in mineral wool fibers as compared to 18% total CaO and MgO content in glass wool fibers makes the mineral wool fibers reactive to acid hydrolysis. By comparison, glass wool fibers have a silica content that is higher than that of mineral wool fibers and the Si—O—Si units in the glass wool fibers are more resistant to acid hydrolysis.

In certain illustrative embodiments, suitable mineral acids for dissolving the mineral wool fibers can include one or more from the group consisting of mineral and/or organic acid mixtures. For example, in certain illustrative embodiments, MAGMA FIBER® is soluble in a solution of 7.5% to 15% HCl acid, or a solution of 20% to 30% HCl acid. In certain illustrative embodiments, MAGMA FIBER® is soluble in a mixture of 10% HCl acid/5% acetic acid. In certain illustrative embodiments, suitable organic acids for dissolving the mineral wool fibers can include acetic acid, citric acid, organic acid, sulfonic acid, formic acid, phosphoric acid and carboxylic acid and such. The addition of mineral acids or organic acids to the gel composition results in a semi-viscous or softened gel. This allows the usage of the gel composition for flowing through porous rock under bottom hole conditions, which results in improved water control when applied to a suitable water-bearing region. This is also particularly relevant when the gel composition has entered a hydrocarbon producing region in the subterranean formation, whereby the mineral acids can be used as a remedial treatment.

In certain illustrative embodiments, the presently disclosed subject matter provides systems and methods for modifying injection or treatment profiles in steam flooding, steam treatments, SAGD, water flood injections, and other injection type operations, using a carrier fluid with inorganic fibers and, in certain embodiments, other materials such as calcium carbonate, silicon oxide, and other acid soluble and non-acid soluble materials like fly ash or silica flour, to improve efficiency and permeable modification characteristics. This can be effective for the following non-limiting examples of processes and methods: ESEIEH processes, cyclic solvent processes, heated solvents, no-condensate gas injection and steam, solvent addition to steam, huff & puff, CSS, cementing, steam driving, steam flooding and variations of other steam and solvent applications to improve production conformance The presently disclosed systems and methods could also improve the injection profile into the formations, thus increasing flow distribution to less permeable areas. This can increase efficiencies in treatment and injection and sweep patterns. In certain illustrative embodiments, acid can be used to remove the inorganic acids from the reservoir of the subterranean formation, which can be desirable as conditions change within the reservoir.

In certain illustrative embodiments, a method of treating a gelling system disposed in a subterranean formation is provided. Inorganic fibers can be added to the gelling system. The gelling system can be a crosslinked hydrocarbon based gelling system having a gelling agent and a crosslinker. The gelling agent can be a phosphonic acid species. The crosslinker can be an iron based crosslinker.

The gel composition or uncrosslinked linear gel system or polymer fluid systems or other fluid systems and related methods described herein have a number of advantages. For example, the gel composition or fluid can be used to improve water shut-off capability in subterranean formations. Also, the mineral wool fibers can improve the gel strength of the final cured gel composition so that it can remain in place within the voids in the subterranean formation. The mineral wool fibers can also act as a diverting agent to provide more efficient fluid coverage. Due to the bridging effect of the mineral wool fibers, the gel composition or polymer compositions can provide a more uniform gel treatment across a wide range of permeability ranges. This bridging effect can be modeled based on fiber particle sizes to equalize flows in different formation permeabilities. The mineral wool fibers also have a high thermal stability which means they can be used to plug large voids and/or permeability streaks during steam flood, steam drive, CSS, huff & puff, SAGD and other steam/steam condensate thermal operations to reduce the effect of steam channeling. In general, the mineral wool fibers can also be used in fire floods, water floods, etc. As the mineral fibers are not soluble in water or oil media, the mineral wool fibers could be added to any water or oil soluble gel system, water, steam, steam condensate or hydrocarbon solutions to carry the particles to the targeted high permeability flow area to divert subsequent treatments or ongoing injection. The use of the fibers in gel/polymer or treatment fluids allows fluids to be diverted and allows the producing zone to be protected in any fluid system.

As the inorganic fibers described in the presently disclosed subject matter are dissolved and gelled in organic or mineral acids, the fibers can also be used to retard acid reactions to carbonate or sandstone reservoirs at high temperature. The gelation achieved in-situ on the formation rock will slow down acid reactions, making the acid penetrate deeper into formation. When acid spends, the gelation is destroyed affording a clean undamaged rock surface.

Addition of inorganic fibers to polymer/gel treatments allows protection of higher permeability zones by decreasing permeability and forcing treatment to the lesser permeable ones. For example, the inorganic fibers can be used for repairing a cement channel behind pipe so invasion of gelants near the hydrocarbon zone can be limited due to creation of filter cake made by the fibers, thus diverting subsequent fluid treatments and/or cement to large voids not lying in the producing zone.

To facilitate a better understanding of the presently disclosed subject matter, the following examples of certain aspects of certain embodiments are given. In no way should the following examples be read to limit, or define, the scope of the presently disclosed subject matter.

### EXAMPLES

### Example 1

### Strengthening Influence on Gel Compositions

A CAPIT-CT™ gel (commercially available from Marathon) with composition 1% GW-97M (medium molecular weight polyacrylamide, HPAM) and 2% GW-90Z (low molecular weight, HPAM) was cross-linked with chromium acetate (XLW-90L) and cured at 150 degrees F. for 24 hours. A J-type ringing gel was derived. Under similar conditions, a MARCIT™ gel (commercially available from Marathon) with 1% GW-97M was cross-linked with XLW-90L and an H-type (non-ringing) gel was derived. 5% THERMAFIBER® (fine) by weight of gel was added to a MARCIT™ gel having 1% GW-97M, and XLW-90L was added and the gel cured for 24 hours at 150 degrees F. A J-type ringing gel like the CAPIT-CT™ gel was derived.

Example 1 demonstrates that mineral wool fibers can be added to high, medium or low molecular weight gels to increase their strengths. The following gel strength codes, as generally set forth in U.S. Pat. No. 4,779,680 to Sydansk, can be used to quantitatively characterize gel strength and are useful for interpreting the results in Example 1.

Gel Strength Codes

A. No detectable continuous gel formed: the bulk of the solution appears to have the same viscosity as the original polymer solution although isolated local gel balls may be present.

B. Highly flowing gel: the gel appears to be only slightly more viscous than the initial polymer solution.

C. Flowing gel: most of the gel flows to the bottle cap by gravity upon inversion.

D. Moderately flowing gel: only a small portion (−10%) of the gel does not readily flow to the bottle cap by gravity upon inversion (usually characterized as a tonguing gel).

E. Barely flowing gel: the gel can barely flow to the bottle cap and/or a significant portion (>15%) of the gel does not flow by gravity upon inversion.

F. Highly deformable nonflowing gel: the gel does not flow to the bottle cap by gravity upon inversion.

G. Moderately deformable nonflowing gel: the gel deforms about half way down the bottle by gravity upon inversion.

H. Slightly deformable nonflowing gel: only the gel surface slightly deforms by gravity upon inversion.

I. Rigid gel: there is no gel surface deformation by gravity upon inversion.

J. Ringing rigid gel: a tuning fork-like mechanical vibration can be felt upon tapping the bottle.

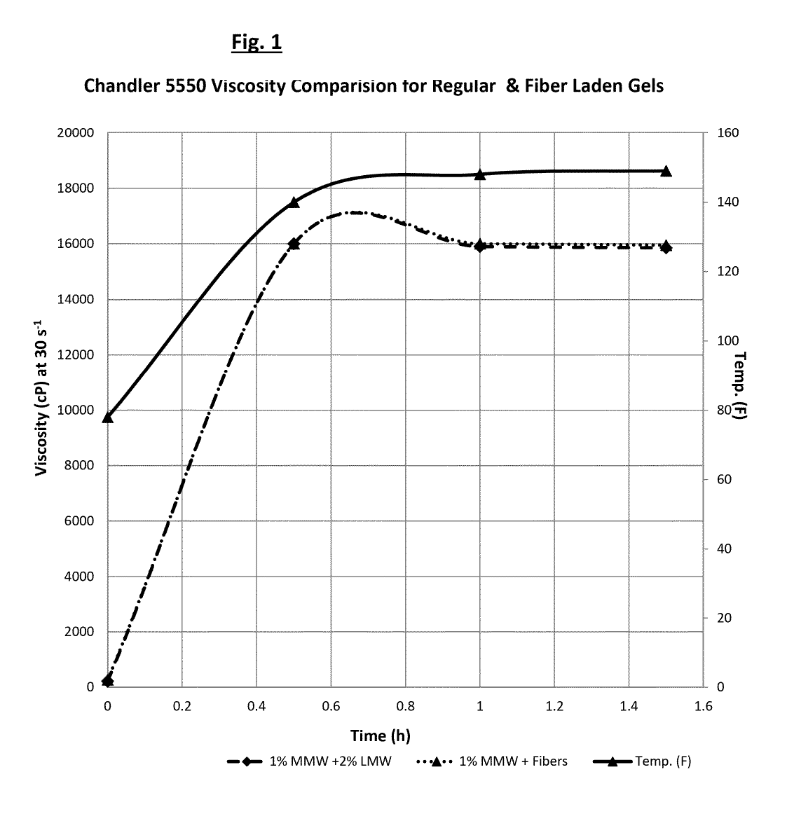

A quantitative estimate of viscosity comparison between the regular CAPIT-CT™ gel (1% MMW+2% LMW HPAM cross-linked) and the fiber laden MARCIT™ gel (1% MMW cross-linked+5% fibers) was made using a Chandler Model 5550 HPHT Viscometer to obtain viscosity measurements. The results of such measurements are shown in FIG. 1, which illustrates that the fiber laden gel can generate equivalent cross-link strength with that of the regular gel.

### Example 2

### Diversion Ability in Formations

MAGMA FIBER® is commercially available in a “fine” form and a “regular” form having different lengths. A surfactant is present in the mineral wool fibers which allows for rapid de-agglomeration in water. Fluid loss tests were run to determine the ability of the mineral wool fibers to reduce flow rate across a 2D to air (K N₂=2D; K Hg=3D aloxite disc) in the presence of delta P=25 psi and at 70 degrees F. in a standard fluid loss cell.

A polymer solution of diutan was used to carry the fibers deep into the formation. Other polymer solutions such as xanthan, guar, modified guar, cellulose, polyacrylamide, or other polymer solutions as would be well known to those skilled in the art, linear and/or cross-linked, could also be used. The object is for the fibers to reduce the flow due to bridging off, and the subsequent fluid to be diverted to the next less permeable zone. This would result in a more effective treatment or sweep of any water, steam, steam condensate, hydrocarbon (butane, propane, gas condensate, or similar/variations)solvents treatment or flooding.

The results of the testing from Example 2 are shown in Table 2 below:

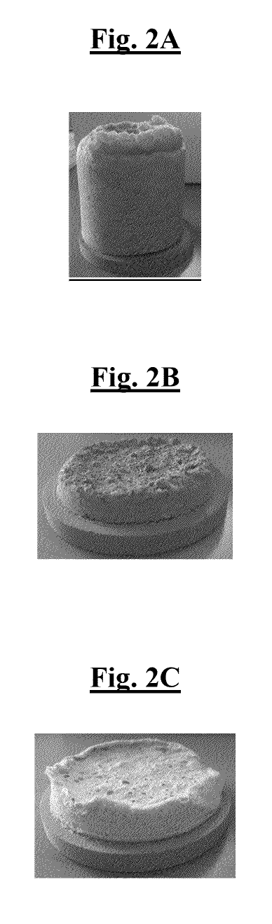

TABLE 2
Test Results for Diversion Ability

| | Flow rate | |
|---|---|---|
| Fluid | (cc/min) | Filter Cake |
| Baseline (water) | 750 | None |
| 24 ptg diutan + 30 ppb ThermaFiber | 80 | See FIG. 2A |
| (1:1 coarse/fine) | | |
| 24 ptg diutan + 30 ppb Sealbond Plus | 10 | See FIG. 2B |
| 24 ptg diutan + 30 ppb Solid Mixture | 8 | See FIG. 2C |
| (1:1:1 Thermafiber coarse/fine/Silica flour) | | |

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter. Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the appended claims.

What is claimed is:

1. A method of treating a subterranean formation, the method comprising:
providing an injection fluid, wherein the injection fluid comprises steam and inorganic fibers;
injecting the injection fluid into the subterranean formation; and
distributing the injection fluid within the subterranean formation or at the wellbore interface.

2. The method of claim 1, wherein the steam and inorganic fibers are provided directly.

3. The method of claim 1, wherein the steam and inorganic fibers are provided in a carrier fluid.

4. The method of claim 1, wherein the steam and inorganic fibers are staged in with a carrier fluid.

5. The method of claim 1, wherein the inorganic fibers comprise mineral wool fibers.

6. The method of claim 1, wherein the injection fluid is introduced to the subterranean formation by one or more of steam flooding, steam drive, cyclic steam stimulation, steam assisted gravity drainage, or huff & puff injection.

7. The method of claim 1, wherein the injection fluid further comprises one or more of calcium carbonate, silicon oxide, acid soluble materials and non-acid soluble materials.

8. The method of claim 1, wherein the inorganic fibers comprise mineral wool fibers that are provided in a mixture of fiber sizes.

9. The method of claim 1, wherein the inorganic fibers comprise mineral wool fibers that have been reduced from their commercially available size.

10. A method of enhancing the distribution of a fluid introduced into a subterranean formation, the method comprising: adding inorganic fibers to the fluid; and introducing the fluid into the subterranean formation.

11. The method of claim 10, wherein the inorganic fibers comprise mineral wool fibers.

12. The method of claim 10, wherein the fluid comprises steam.

13. The method of claim 10, wherein the fluid comprises cement.

14. The method of claim 10, wherein the fluid comprises a solvent material.

15. The method of claim 14, wherein the solvent material is aqueous.

16. The method of claim 14, wherein the solvent material is hydrocarbon based.

17. The method of claim 10, wherein the fluid further comprises one or more of calcium carbonate, silicon oxide, acid soluble materials and non-acid soluble materials.

18. The method of claim 10, wherein the fluid is introduced to the subterranean formation by one or more of steam injection, steam flooding, water flooding, steam drive, cyclic steam stimulation, steam assisted gravity drainage, no-condensate gas injection, huff & puff injection, cementing, enhanced solvent extraction incorporating electromagnetic heating or a cyclic solvent process.

19. The method of claim 10, wherein the inorganic fibers comprise mineral wool fibers that are provided in a mixture of fiber sizes.

20. The method of claim 10, wherein the inorganic fibers comprise mineral wool fibers that have been reduced from their commercially available size.

21. A method of modifying the injection profile of a steam or other injection process for a subterranean formation, the method comprising: introducing inorganic fibers into the injection stream; and injecting the injection stream into the subterranean formation or onto the wellbore interface.

22. The method of claim 21, wherein the inorganic fibers are introduced into the injection stream directly.

23. The method of claim 21, wherein the inorganic fibers are introduced into the injection stream with a carrier fluid.

24. The method of claim 21, wherein the inorganic fibers are introduced into the injection stream in stages.

25. The method of claim 21, wherein the inorganic fibers are mineral wool fibers.

26. The method of claim 21, wherein the inorganic fibers comprise mineral wool fibers that are provided in a mixture of fiber sizes.

27. The method of claim 21, wherein the inorganic fibers comprise mineral wool fibers that have been reduced from their commercially available size.

28. A method of treating mineral wool fibers that have been introduced into a subterranean formation during an injection process, the method comprising: supplying an acid to the subterranean formation or a wellbore interface thereof; and dissolving the mineral wool fibers in the acid.

29. The method of claim 28, wherein the acid comprises one or more from the group consisting of mineral acid and organic acid.

30. A gel composition for use in a subterranean formation, the gel composition comprising: an aqueous fluid; a cross-linkable polymer soluble in the aqueous fluid; a cross-linking agent; and inorganic fibers, wherein the inorganic fibers comprise mineral wool fibers provided in a mixture of fiber sizes.

31. A gel composition for use in a subterranean formation, the gel composition comprising: an aqueous fluid; a cross-linkable polymer soluble in the aqueous fluid; a cross-linking agent; and inorganic fibers, wherein the inorganic fibers comprise mineral wool fibers that have been reduced from their commercially available size.

32. A method of enhancing the distribution of a fluid introduced into a subterranean formation, the method comprising: adding inorganic fibers to the fluid; and introducing the fluid onto a wellbore interface of the subterranean formation.

33. A method of modifying the injection profile of a steam or other injection process for a subterranean formation, the method comprising: introducing inorganic fibers into the injection stream; and injecting the injection stream onto a wellbore interface of the subterranean formation.

34. A gel composition for use in a subterranean formation, the gel composition comprising:
an aqueous fluid;
a cross-linkable polymer soluble in the aqueous fluid;
a cross-linking agent; and
inorganic fibers.

35. The gel composition of claim 34, wherein the inorganic fibers comprise mineral wool fibers.

36. A method of plugging an opening in a subterranean formation, the method comprising:
providing a gel composition comprising an aqueous fluid, a cross-linkable polymer soluble in the aqueous fluid and a cross-linking agent;
adding inorganic fibers to the gel composition;
injecting the gel composition into the opening in the subterranean formation;
cross-linking the gel composition; and
plugging the opening with the gel composition.

37. The method of claim 36, wherein the inorganic fibers comprise mineral wool fibers.

38. A method of treating a gel composition disposed in a subterranean formation, the gel composition comprising an aqueous fluid, a cross-linkable polymer soluble in the aqueous fluid, a cross-linking agent and mineral wool fibers, the method comprising:
applying an acid to the subterranean formation; and
dissolving the mineral wool fibers in the acid.

39. The method of claim 38, wherein the acid comprises one or more from the group consisting of mineral acid and organic acid.

40. A method of unplugging an opening in a subterranean formation, wherein the opening is at least partially filled with a cured gel composition, the cured gel composition comprising an aqueous fluid, a cross-linkable polymer soluble in the aqueous fluid, a cross-linking agent and mineral wool fibers, the method comprising:
supplying an acid to the subterranean formation;
dissolving the mineral wool fibers from the cured gel composition in the acid; and
softening the cured gel composition.

41. The method of claim 40, wherein the acid comprises one or more from the group consisting of mineral acid and organic acid.

42. A composition for use in a subterranean formation, the composition comprising:
an aqueous fluid;
a polymer or viscous fluid soluble in the aqueous fluid; and
inorganic fibers.

43. The composition of claim 42, wherein the composition comprises one or more of an uncrosslinked gel system, a polymer composition, or a viscous fluid composition.

44. The composition of claim 42, wherein the inorganic fibers comprise mineral wool fibers.

45. A method of plugging an opening in a subterranean formation, the method comprising:
providing an uncrosslinked gel system or polymer or viscous fluid composition comprising an aqueous fluid and a polymer or viscous fluid soluble in the aqueous fluid;
adding inorganic fibers to the uncrosslinked gel system or polymer or viscous fluid composition;
injecting the uncrosslinked gel system or polymer or viscous fluid composition into the opening in the subterranean formation; and
plugging the opening with the uncrosslinked gel system or polymer or viscous fluid composition.

46. The method of claim 45, wherein the inorganic fibers comprise mineral wool fibers.

47. A method of treating a composition disposed in a subterranean formation, the composition comprising an aqueous fluid, a polymer or viscous fluid soluble in the aqueous fluid, and mineral wool fibers, the method comprising:
supplying an acid to the subterranean formation; and
dissolving the mineral wool fibers in the acid.

48. The method of claim 47, wherein the composition comprises one or more of an uncrosslinked gel system, a polymer composition, or a viscous fluid composition.

49. The method of claim 47, wherein the acid comprises one or more from the group consisting of mineral acid and organic acid.

50. A method of unplugging an opening in a subterranean formation, wherein the opening is at least partially filled with a cured uncrosslinked gel system or polymer or viscous fluid composition, the uncrosslinked gel system or polymer or viscous fluid composition comprising an aqueous fluid, a polymer or viscous fluid soluble in the aqueous fluid, and mineral wool fibers, the method comprising:
supplying an acid to the subterranean formation;
dissolving the mineral wool fibers from the cured uncrosslinked gel system or polymer or viscous fluid composition in the acid; and
softening the uncrosslinked gel system or polymer or viscous fluid composition.

51. The method of claim 50, wherein the acid comprises one or more from the group consisting of mineral acid and organic acid.

52. A method of treating a gelling system in a subterranean formation, the method comprising adding inorganic fibers to the gelling system, wherein the gelling system is a crosslinked hydrocarbon based gelling system having a gelling agent comprising a phosphonic acid species and a crosslinker comprising an iron based crosslinker.
